(19) United States
(12) Patent Application Publication
(10) Pub. No.: US 2022/0063769 A1
(43) Pub. Date: Mar. 3, 2022

(54) Suction Anchors for Securing Structures to an Underwater Floor

(71) Applicants: Jason Rust Cotrell, Boulder, CO (US); Rick Damiani, Arvanda, CO (US); Massimo Franchi, Pescara (IT)

(72) Inventors: Jason Rust Cotrell, Boulder, CO (US); Rick Damiani, Arvanda, CO (US); Massimo Franchi, Pescara (IT)

(21) Appl. No.: 17/446,081

(22) Filed: Aug. 26, 2021

Related U.S. Application Data
(60) Provisional application No. 63/074,424, filed on Sep. 3, 2020.
(60) Provisional application No. 63/088,287, filed on Oct. 6, 2020.

(51) Int. Cl. B63B 21/27; E02D 5/30; B63B 21/20; B33Y 10/00; B33Y 80/00; B28B 1/00; B28B 11/24; B33Y 40/20

(52) U.S. Cl. CPC B63B 21/27; E02D 5/30; B63B 21/20; B33Y 10/00; E02B 2017/0078; B28B 1/001; B28B 11/24; B33Y 40/20; E02D 2250/00; B33Y 80/00

(57) ABSTRACT

In a general aspect, suction anchors are disclosed that include a tubular body formed at least in part of cementitious materials. The tubular body has a closed end, an open end, and a perimeter wall. The perimeter wall defines a shape of the tubular body and is former at least in part of the cementitious materials. The tubular body also includes a channel internal to the perimeter wall defining a spiral around a longitudinal axis of the tubular body. The tubular body additionally includes an edge defining an opening for the open end. The edge is configured to penetrate the underwater floor. The suction anchors also include a post-tensioning device through the channel in a tensioned state and a port configured to fluidly-couple at least part of a cavity within the tubular body to an exterior of the tubular body.

### CROSS-REFERENCE TO RELATED APPLICATIONS

This application claims priority to U.S. Prov. App. No. 63/074,424, which was filed on Sep. 3, 2020 and entitled, “Suction Anchors for Securing Structures to an Underwater Floor;” and to U.S. Prov. App. No. 63/088,287, which was filed on Oct. 6, 2020 and entitled, “Suction Anchors for Securing Structures to an Underwater Floor.” Both priority applications are hereby incorporated by reference in their entirety.

### BACKGROUND

The following description relates to suction anchors for securing structures to an underwater floor.

### DESCRIPTION OF DRAWINGS

FIG. 1A is an example system for fabricating large structures from additive materials using 3DCP or 3D casting;

FIG. 1B is an example system for fabricating large structures using 3DCP or 3D Casting that is mounted on wheels and includes a roof for shelter;

FIG. 1C is an example gantry system for fabricating large structures using 3DCP or 3D Casting and example method of manufacturing anchors;

FIG. 2A is a schematic diagram, in perspective view, of an example suction anchor for securing structures to an underwater floor;

FIG. 2B is a schematic diagram, presented in side and bottom views, of the example suction anchor of FIG. 2A, including various section views associated with the side and bottom views;

FIG. 2C is a semi-transparent view of the example suction anchor of FIG. 2A, but with tendons arranged in an example spiral configuration;

FIG. 2D is an elevation view of multiple instances of the example suction anchor of FIG. 2A securing wind turbine structures to the underwater floor;

FIG. 2E is a semi-transparent side view of a hybrid steel and concrete suction anchor and example eye connection;

FIG. 2F is a partial section view of a suction anchor and example pad eye connection system using tendons;

FIG. 2G is a perspective view of a suction anchor and example pad eye connection system using fasteners;

FIG. 2H is a side view of a suction anchor and example external bridle connection system;

FIG. 2I is a semi-transparent side view of a suction anchor and example embedded bridle connection system;

FIG. 2J is a partial section view of a suction anchor and reinforcement system and example tendon pad eye connection system;

FIG. 3A is a schematic diagram, in perspective view, of a group of 3D-printed suction anchor (3DSA) units being horizontally wet-towed by tugboats from a quay where the 3DSA units were manufactured and assembled;

FIG. 3B is a schematic diagram, in perspective view, of assembled 3DSA units of FIG. 3A being horizontally wet-towed by tugboats along an open body of water to a target location; and

FIG. 3C is an example of hoisting a suction anchor using lifting eyes.

### DETAILED DESCRIPTION

Many anchors that moor floating offshore wind turbines are too large to transport over roads, waterways, or rail due to their extremely large dimensions either as individual components, or as assemblies. Moreover, many existing on-site production methods, such as weldments and conventional concrete construction, are too expensive and too slow for the large production volumes needed for modern wind plants. In some implementations, the manufacturing technologies and processes described herein can provide improvements over certain existing technologies and processes. For example, the technologies described may, in certain instances increase production rates, reduce transportation costs, or reduce the capital costs of mooring systems for energy devices such as wind and water power technologies. In addition, methods of assembling and transporting and installing anchors from the manufacturing or assembly areas to the installation site are needed in regions where large specialized anchor handling vessels are not sufficiently available or are too expensive to use.

Suction anchors for floating offshore wind turbines and waterpower devices are typically made from rolled and welded steel cylindrical sections and steel plate sections. The sections become progressively expensive to manufacture and transport for larger anchors due to weight and size limits from road, waterway, and rail constraints such as bridges, tunnels, and overhead signals. For example, the maximum diameter of an anchor for a wind turbine that can be transported over land is less than 4.6 m in most U.S. regions; however, the required diameter of an anchor could exceed 5 m potentially reaching a required diameter of approximately 15 m. Conventional suction pile anchors are the third largest component cost to manufacture for a typical floating offshore wind plant, after turbine and substructure. A 5-m diameter anchor for an offshore wind turbine may cost upwards of approximately $1.5 million to manufacture and install.

In some aspects of what is described here, systems and methods are disclosed that additively manufacture anchors on-site, or that manufacture foundation and tower components in smaller modular sections for transportation to the assembly site. The systems and methods may also be used to additively manufacture suction anchors (or portions thereof) for securing large structures to an underwater floor (e.g., an ocean floor, a lake floor, a river bed, etc.). The large structures include offshore wind turbines or waterpower devices. The systems and methods may employ additive materials that are less expensive than conventional materials, or that use additive or other manufacturing methods to manufacture smaller modular components. For example, the additive manufacturing systems and methods may reduce the capital cost of an anchor by up to 80% compared to conventionally manufactured anchors, make use of low-cost, regionally sourced cementitious or ceramic materials without expensive temporary formwork, and increase production speed using automation.

In some examples, the systems and methods use additive manufacturing (AM), other concrete manufacturing methods, or combination thereof to manufacture the suction anchor, or any combination thereof, for wind turbines installed at or near the location where the support structures are assembled or installed. Such manufacturing may be called, respectively, on-site and near-site manufacturing. In the case of waterpower devices, offshore-wind turbine installations, and equipment, additive manufacturing, other concrete manufacturing methods, or combination thereof can be used for on-site at or near-site construction at or near the dock or port where the turbines and foundations are assembled and staged before being transported by sea to the offshore installation site. By manufacturing structures and foundations on-site or near-site using additive manufacturing methods or other manufacturing methods, transportation may become substantially easier and cheaper than by manufacturing large components far away from the installation site at in-land factories, or by manufacturing and importing the anchors by water borne vessels far away from the installation site. For instance, instead of transporting over-sized wind turbine anchors, contractors or other construction personnel may simply transport a mobile additive manufacturing system, along with a relatively smaller amount of additive manufacturing material to or near the manufacturing or installation site. Other manufacturing methods such as concrete casting, match casting, or pre-casting can be used to supplement or to replace the additive manufacturing methods. That is, the structures and/or foundations described herein may be manufactured with related techniques to produce hybrid anchors. For larger wind plant installations, existing material production infrastructure, such as concrete batch plants used for foundations, may be used to produce material for the manufacturing systems. In this way, the systems and methods described herein may reduce the cost of transporting over-sized structures over roads, rail lines, or waterways and reduce the time and cost required to construct the structures.

Additive manufacturing, sometimes referred to as “3D printing,” creates parts using a layered deposition process to form a three-dimensional (3D) structure by adding layers-upon-layers of materials. Additive manufacturing using cementitious or ceramic materials, sometimes called 3D Concrete Printing (3DCP), can be used for large structures, such as a tower, a substructure, or a foundation for wind turbines or waterpower devices. A fast method of 3DCP, referred to here as “3D-casting”, uses additive manufacturing to directly 3D-print an initial section of the exterior and interior wall surfaces up to several meters high or taller without a temporary formwork. After a period of hardening, concrete or other cementitious materials are poured or “cast” between the surfaces and allowed to harden. Reinforcement materials such as steel rebar or fibrous mesh can be deposited between the wall surfaces before adding the cast materials to provide additional strengthening of the wall section. Fibrous reinforcement materials can also be mixed into the walls or cast materials before being added to the structures. After sufficient hardening of the cast and 3D printed or cast materials, additional layers of additive materials can then be deposited on top of the lower section of the 3D-cast component to increase the height of the structure by building upper portions of the walls or tower in additional sections. Alternatively, one or more additional sections of wall surfaces can be manufactured and stacked upon the initial wall surface before additional reinforcement or cast materials are inserted into the initial and stacked wall surfaces in order to reduce the mass and weight of the additive layers to be hoisted. In either case, the 3D-casting processes may be repeated to manufacture additional upper sections resulting in tall support structures that may reach tens of meters high.

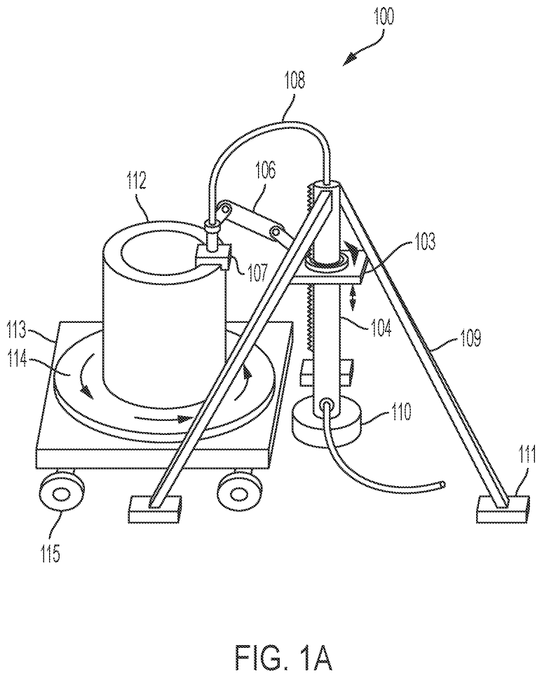

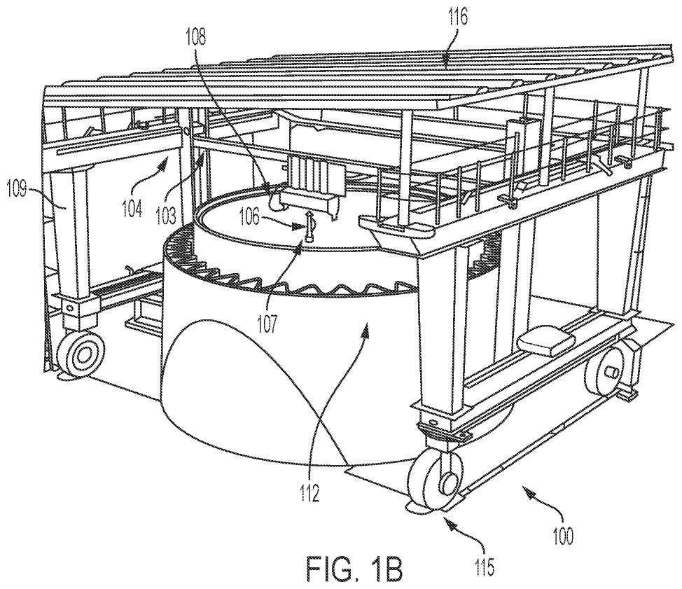

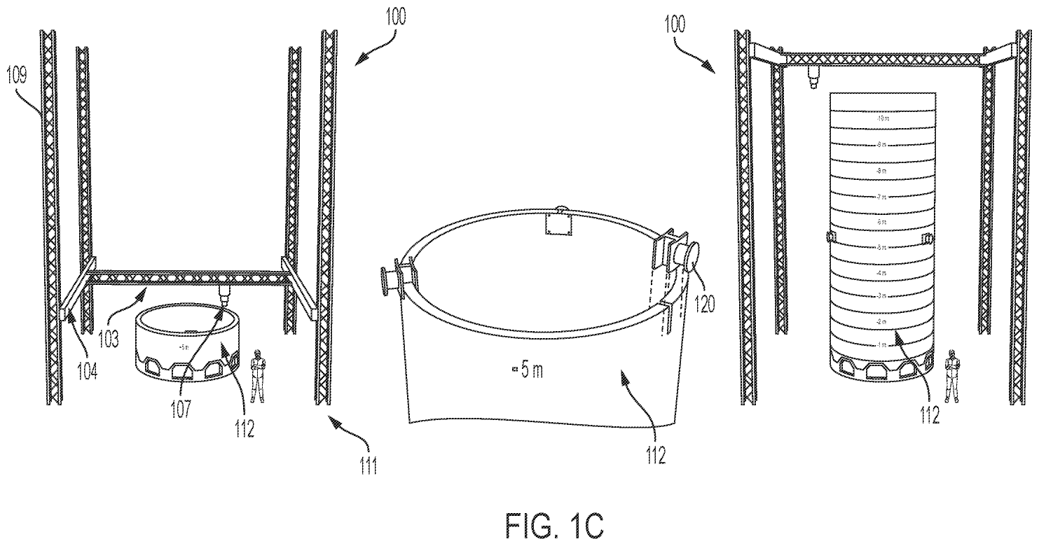

Now referring to FIG. 1A, an example system 100 is presented for fabricating large structures from additive materials using 3DCP or 3D casting. FIG. 1A is not necessarily illustrated to scale. The example system 100 includes a fixed or mobile platform to support and position a tower or foundation body portion for manufacturing. The system 100 also includes a print head positioned by an articulated arm for depositing additive manufacturing materials, such as cementitious or other materials. The print head may include a means of imbedding reinforcement into the additive manufacturing material. The system 100 additionally includes a platform and drive system to adjust the vertical position of the articulated arm in which the print head is configured to output, onto at least one wall, additive manufacturing material. In some variations, the print head is positioned using a moveable arm supported by a gantry structure. FIG. 1A depicts the example system 100 as including a platform 103, a guide 104, a drive unit 105, an articulated arm 106, a print head 107, a delivery tube 108, a support arm 109, and feet 110, 111 or wheels 115, or enclosures on the top 116, sides, or bottom of the example system 100. The example system 100 may include a means of supporting and positioning a manufactured structure 112, which may include a turntable 114, and a cart 113 positioned with tracks or wheels 115. In some variations the wheels 115 are drive by motors to position the printer in the horizontal plane. Each wheel 115 may be driven or positioned collectively or separately in various directions to facilitate repositioning of the system 100. FIG. 1A illustrates one example of a structure fabrication system. FIG. 1B illustrates a second example of a structure fabrication system. FIG. 1C illustrates a third example of a structure fabrication system and shows example steps for manufacturing an anchor section 112. Other structure fabrication systems having more, fewer, or different components may be used in other embodiments.

In some implementations, the example print head 107 is configured to deposit cementitious, ceramic, reinforcement, or other additive materials by extruding them onto the printed surface. The print head 107 may be configured to shape the additive materials as they are deposited. In some implementations, the print head 107 is configured to spray the additive materials onto a surface, such as with a process commonly called shotcrete for cementitious or ceramic materials. The shotcrete process may allow for faster material deposition, the ability to deposit materials horizontally or from below, and the ability to more fully cover reinforcement materials that are added to the structure manually or in an automated fashion.

In some implementations, the example system 100 may include one or more additional components (e.g., sensors, an arm, etc.) to finish the surfaces of the manufactured structure 112. Such finishing may be for aesthetic purposes or to facilitate joining of one or more body portions. During additive manufacturing, the example system 100 may intentionally or unintentionally create uneven surfaces during construction of the structure 112. Thus, the example system 100 may include additional components to smooth out such unevenness. The additional components may be attached to the articulated arm or be added as one or more additional arms.

The example system 112 may be integrated and built as a single piece or manufactured as two or more separate pieces that are joined together using fasteners, post-tensioning tendons, or the like. Furthermore, in some variations, related structures, such as sections made of concrete or rolled steel shapes, can be placed and joined directly on top of an anchor section of the manufactured structure 112. That is, the manufactured structure 112 may be combined with related techniques to produce hybrid structures and foundations (e.g., a hybrid anchor). Fasteners or post-tensioning tendons can also be used to further strengthen the manufactured structure 112 by applying compressive stresses to the structure, thereby reducing the number or magnitude of tensile loads in the concrete. The fasteners or post-tensioning tendons may be part of a method to pre-stress the manufactured structure 112, and in some variations, extend into an open end or a closed end of the manufactured structure 112. For example, the manufactured structure 112 may correspond to an anchor (e.g., a suction anchor) and the fasteners or post-tensioning tendons may extend into an open end or a closed end of the anchor.

The manufactured structure 112 (or portion thereof) may be manufactured using additive or other manufacturing processes positioned vertically or horizontally. In a 3D-casting manufacturing process, the leg's inner and outer surface profiles and any interior features such as cavities can be printed in successive layers up to approximately 2 inches tall. In some cases, reinforcements (such as fiberglass, basalt, or steel rebar or fibers) can be positioned between the inner and outer surfaces in each section after the section height reaches approximately one to three meters, and before additional cast materials are added to the section. After the walls strengthen, cementitious, ceramic, or other additive materials, potentially mixed with reinforcing fibers, are poured into the volume between the inner and outer surfaces. An example reinforcement design is to use an Engineered Cementitious Composite (ECC) concrete and post-tensioning across the layers and sections to withstand the loads on the leg, potentially eliminating the need for manual rebar placement. The ECC concrete may include mortar-based composites reinforced with specially selected short random fibers such as steel, polymer, or organic fibers. After the cast materials strengthen, the inner and outer surfaces for the next 3DCP-cast section may be printed on the previous section. The section-on-section construction process may be similar to the concrete construction process known as match-casting for bridges and some concrete wind turbine towers. 3DCP match-casting can eliminate the need for expensive mortar or machining operations between layers by printing new sections on top of lower sections. In some examples, after printing, the 3DCP components cure for a period of up to 4 weeks depending on the materials. Components needed for moving and transporting the manufactured structure 112 such as hoisting fixtures 120 may be embedded in the structure 112 during manufacturing. For example, the manufactured structure 112 may correspond to an anchor and the hoisting fixtures 120 may include one or more pad eye connections. The sections may then be post-tensioned in various directions such as across the additive layers and match-cast joints using post tensioning rods, tendons or fasteners or the like during assembly in order to strengthen the sections in various directions. Additional 3DCP components such as mooring line connections, lifting eyes, or both, may then be attached to the structure using post tensioning rods, tendons or fasteners.

For manufactured structures 112 deployed in bodies of water (e.g., an anchor), the manufactured structure 112 may be manufactured to be entirely or partially below the seafloor. For example, the manufactured structure may correspond to a suction anchor configured to be entirely or partially below the seafloor. In some variations, the manufacture structure 112 may extend above the water surface.

In some aspects of what is described here, the systems and methods disclosed herein may also be used to additively manufacture suction anchors (or portions thereof) for securing structures to an underwater floor (e.g., an ocean floor, a lake floor, a river bed, etc.). Approximately 60% of the U.S. offshore wind resource area is in water depths greater than 60 m—too deep for conventional fixed-bottom substructures. Floating wind turbines, however, face several challenges, especially with regard to station keeping and mooring, e.g., high anchor fabrication and installation costs, installation location precision, installation time, installation in high wind, wave, and current conditions, mooring sea-keeping performance, and structural reliability.

In shallower floating sites (e.g., up to 100 m), mooring is particularly demanding because of the need to avoid line snap-loads that are promoted by both challenging wave regimes and reduced mooring hydrodynamic stiffness—especially with catenary systems. This is accompanied by increased line and anchor loads, especially cyclic vertical loads that cannot be easily handled by conventional embedment anchors. In these cases, seabed stresses caused by wave induced loading propagate into the subsoil and increase pore water pressure leading to a potential for liquefaction. In deeper waters (e.g., 250-1000 m), mooring lines are long, heavy, and expensive. Furthermore, especially in the case of steel catenary mooring, heavy lines increase demands on the floating foundation and have a wide footprint that impacts fishing operations.

Suction anchors are a preferred floating turbine anchor solution, as they can be installed in nearly all water depths, withstand omnidirectional loading, and can be installed with high location accuracy. Suction anchors have potential for use in all water depths with virtually any floating substructure configuration (e.g., semi-submersible, barge, spar, and tension leg), and any mooring layout (e.g., catenary, semi-taut, and taut). Suction anchors offer faster installation speeds, resist multi-directional loading, reduce mooring footprint, improve installation position precision, and work well with shared mooring and synthetic mooring lines. However, they have been associated with high costs, partly due to the large steel quantities and extensive manufacturing labor, and partly because of the specialized anchor handling vessels used for deployment. In addition, many countries import steel anchors because they do not have the existing supply chain efficiencies to manufacture suction buckets domestically.

The systems and methods disclosed herein may be used to realize 3D concrete printed suction anchors (3DSA) or other structures. 3DSA draws upon and combines the advantages offered by anchoring solutions already existing in the industry, into an innovative, cost-disruptive design. 3DSA also uses low-cost 3D concrete printing technologies, with domestically available concrete materials to manufacture low-cost suction anchors that can be floated to the installation site with inexpensive, readily-available tugs.

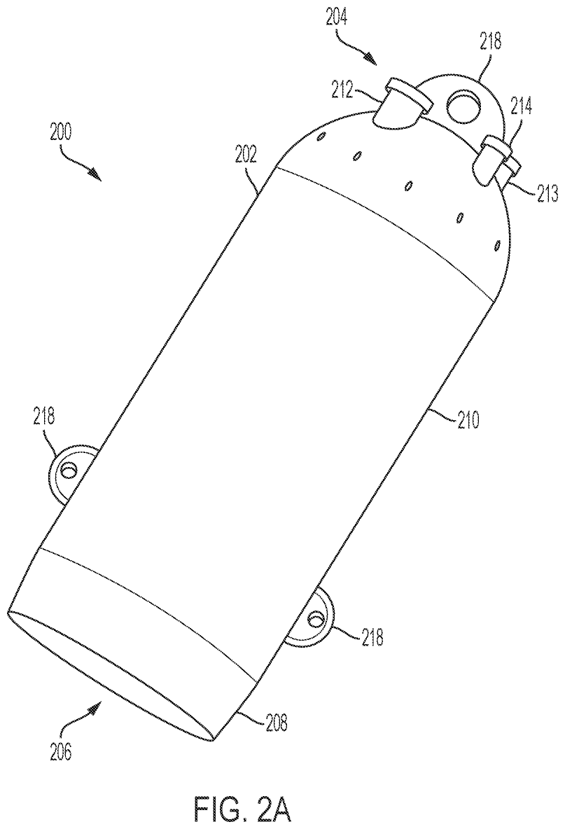

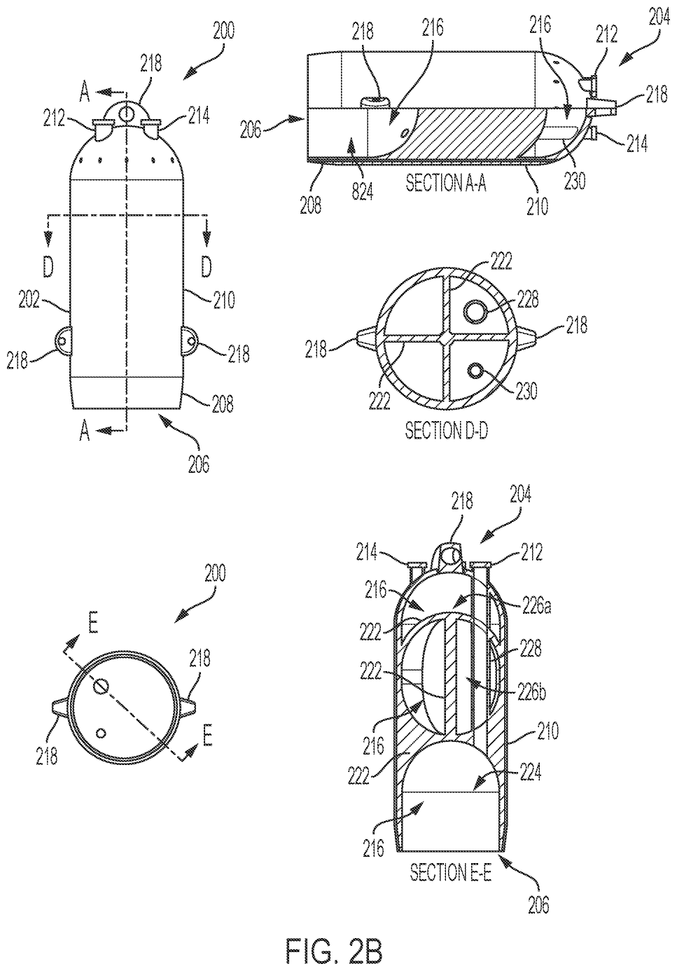

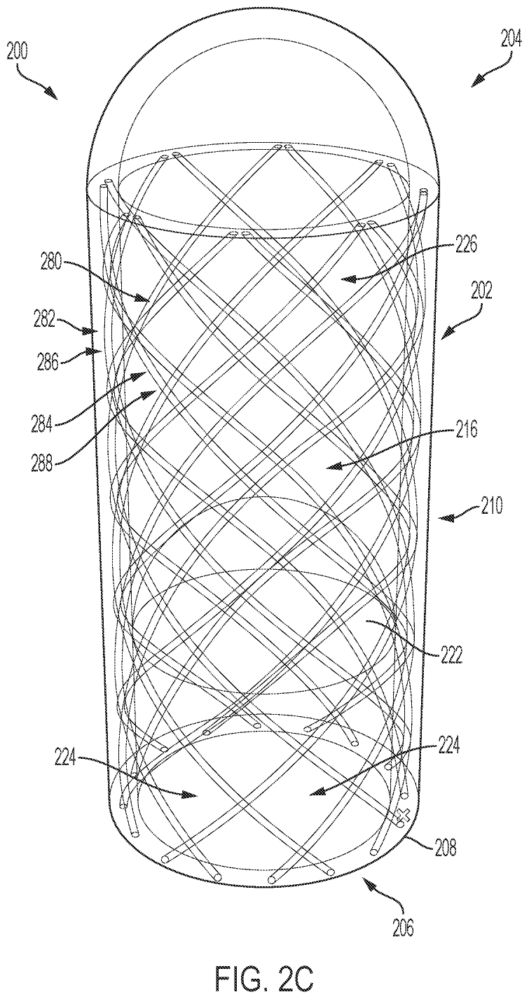

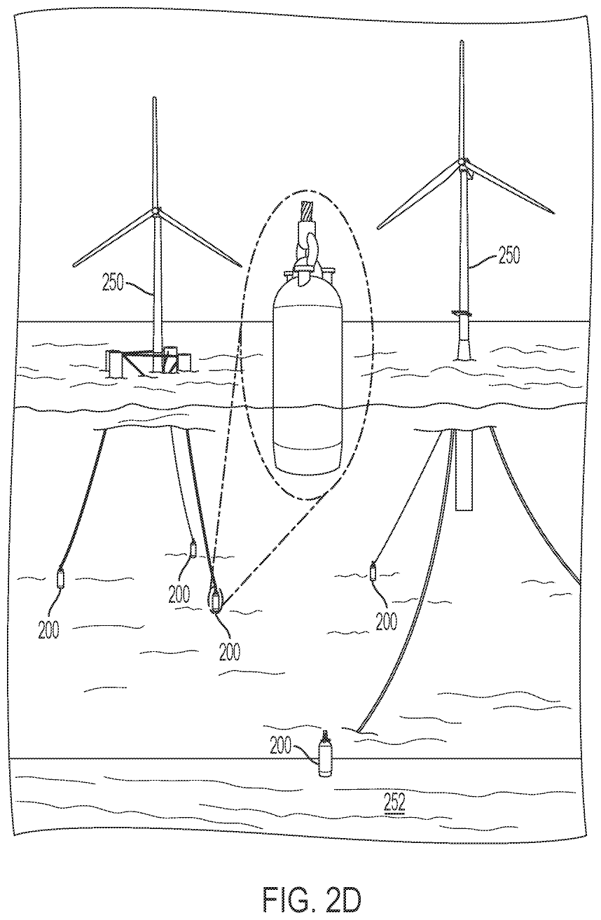

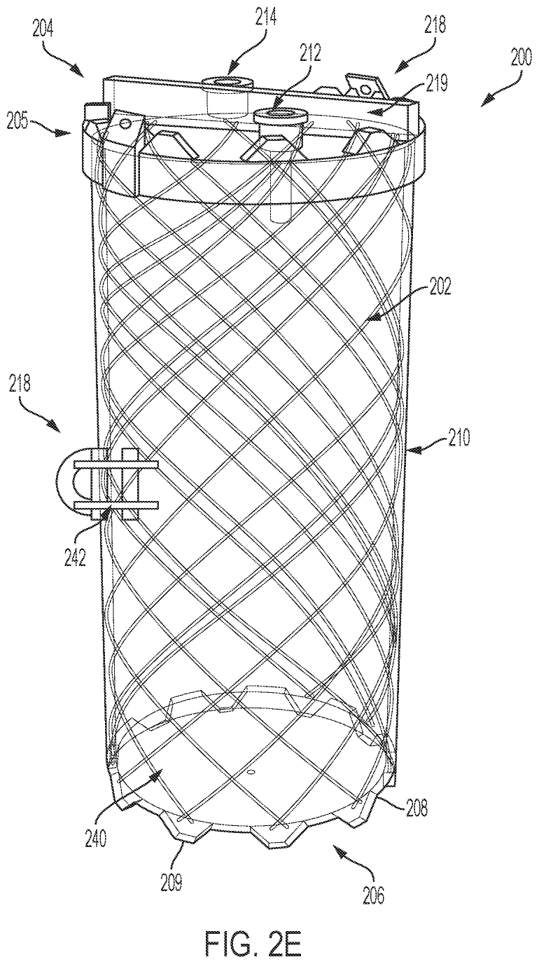

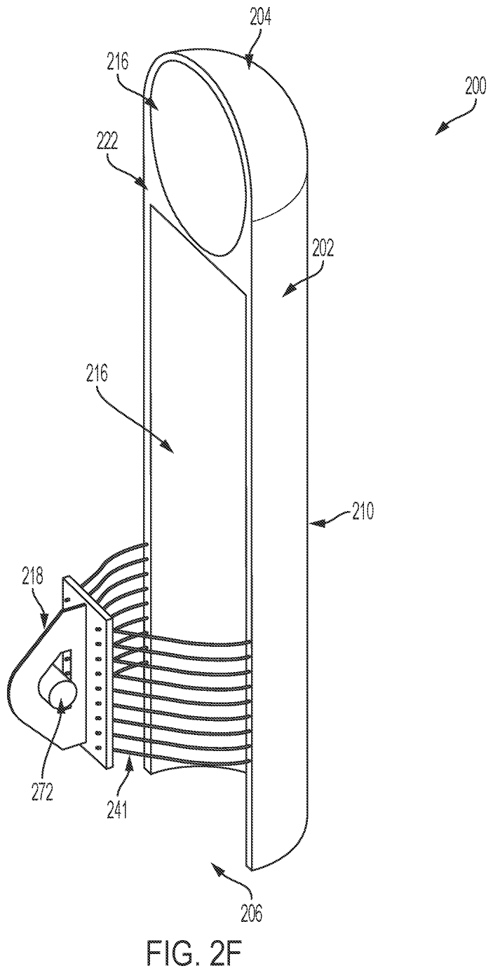

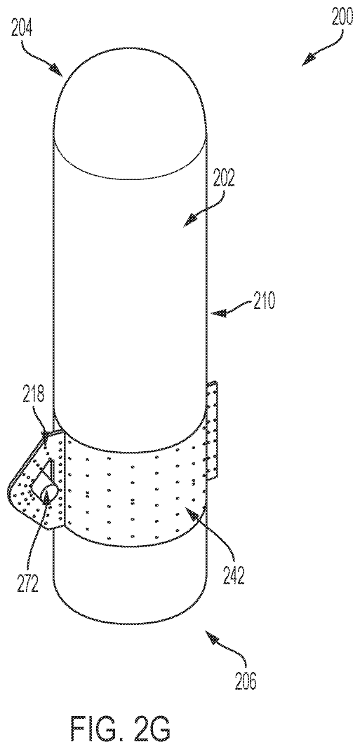

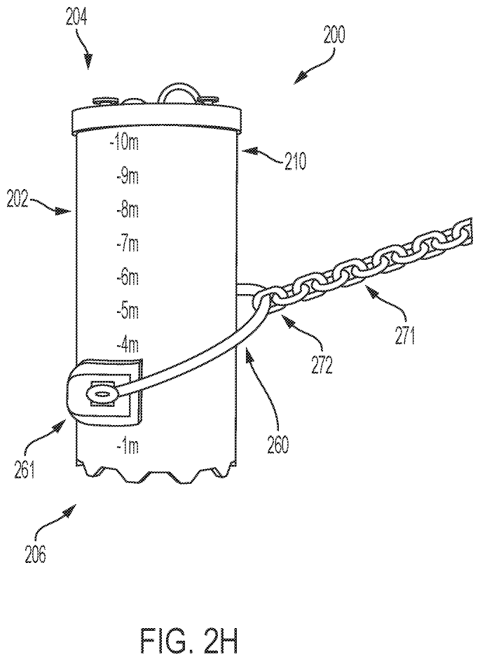

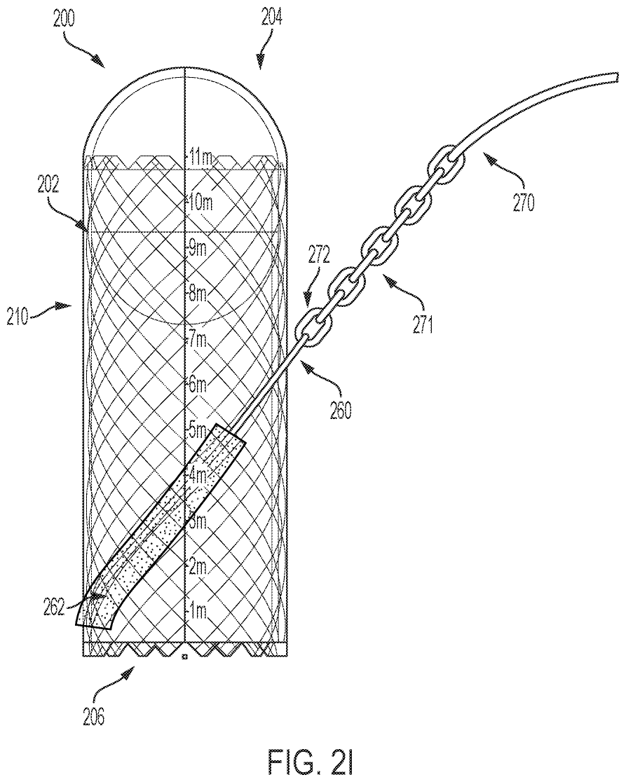

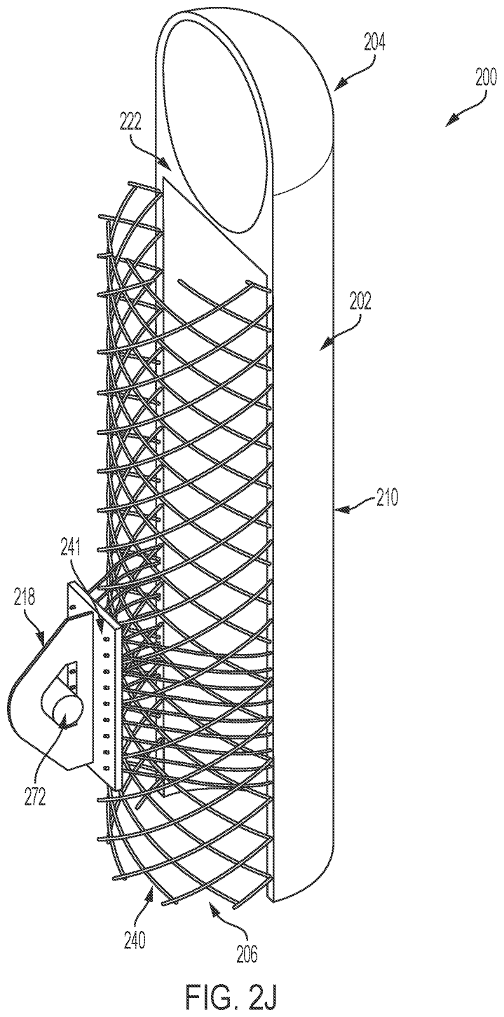

Now referring to FIG. 2A, a schematic diagram is presented, in perspective view, of an example suction anchor 200 for securing structures to an underwater floor. The example suction anchor 200 may also be referred to as a suction pile, a suction caisson, a suction bucket, or a suction installed caisson anchor. FIG. 2B presents a schematic diagram, in side and bottom views, of the example suction anchor 200 of FIG. 2A, including various section views associated with the side and bottom views. FIG. 2C presents a semi-transparent view of the example suction anchor 200 of FIG. 2A, but with tendons 240 arranged in an example spiral configuration. The example suction anchor 200 may be configured to submerge and penetrate into the underwater floor, and once penetrated, remain embedded, such as by water pressure against exterior surfaces of the example suction anchor 200. Examples of the underwater floor include an ocean floor, a sea floor, a lake floor, or a riverbed. FIG. 2D presents a schematic diagram, in elevation view, of multiple instances of the example suction anchor 200 of FIG. 2A securing wind turbine structures 250 to the underwater floor 252.

The suction anchor 200 includes a tubular body 202 formed at least in part of cementitious materials and having a closed end 204 and an open end 206. The portion of the tubular body 202 formed of cementitious materials may include layers of successively deposited cementitious materials, such as those deposited by 3DCP or 3D-casting processes. Such processes may manipulate a flowable cementitious material (e.g., via extrusion, spray, printing, etc.) that subsequently hardens into a solidified cementitious material. For example, the flowable cementitious material may be deposited as successive layers that harden into a solidified body. The successive layers may be disposed on top of each other such that a subsequent layer comes in direct contact with a prior layer. However, intervening structures may be possible between adjacent layers, such as a support mesh, rebar, etc. The solidified body may then define part or all of the tubular body 202. The tubular body 202 includes an edge 208 defining an opening of the open end 206 and configured to penetrate the underwater floor 252. In some variations, the edge 208 tapers towards the opening of the open end 206. In these variations, the taper may terminate in a tip sufficiently sharp to penetrate the underwater floor 252 but not fail mechanically (e.g., crack crumble, etc.). In some variations, the edge 208 is formed of a metal or metal alloy (e.g., steel). In these variations, the edge 208 may include surfaces configured to bond to cementitious material. For example, the surfaces may have a texture or be chemically treated to bond with cementitious material (or improve such a bond).

In many implementations, a perimeter wall 210 defines a shape of the tubular body 202. The perimeter wall 210 may have a cross section that is constant or varies from the closed end 204 to the open end 206. Examples of the cross section include a circular cross section, a square cross section, a hexagonal cross section, a sinusoidal cross section, and a ribbed cross section. Other cross sections are possible. In FIGS. 2A-2J, the tubular body 202 includes a perimeter wall 210 with a circular cross-section that is more or less constant from the closed end 204 to the open end 206, except along the hemispherical taper of the closed end 204. Along the hemispherical taper, the shape of the circular cross-section remains constant, but the radius of the cross section decreases until reaching an apex of the closed end 204 (where the radius is zero).

The example suction anchor 200 also includes one or more ports 212, 213, 214 (or hatches) configured to fluidly couple a cavity 216 within the tubular body 202 (or respective parts of the cavity 216) to an exterior of the tubular body 202. The one or more ports 212, 214 (or hatches) may be disposed through or include an orifice in the perimeter wall 210. The one or more ports 212, 214 (or hatches) may also be configured to allow a source of suction (e.g., a pump), a source of fluid (e.g., an air compressor), or both, to couple to the example suction anchor 200. In some variations, part or all of the one or more ports 212, 214 is formed of metal (e.g., steel). In some variations, the cavity 216 extends uninterrupted from the closed end 204 to the open end 206 (or opening thereof). For example, the tubular body 202 may define a simple bucket shape. In these variations, the example suction anchor 200 may include a single port to fluidly couple the cavity 216 to the exterior of the tubular body 202. In other variations, such as shown in FIGS. 2B and 2C, the cavity 216 extends from the closed end 204 to the open end 206 (or opening thereof) and is interrupted by one or more walls partitioning the cavity 216 into chambers. Each chamber may be fluidly coupled to the exterior of the tubular body 202 through a single, respective port. Such fluid coupling may be allowed by conduits internal to the example suction anchor 200.

The example suction anchor 200 additionally includes a pad eye 218 extending from an outer surface of the tubular body 202 and configured to couple to a mooring line. For example, the pad eye 218 may be a plate structure extending from the outer surface of the tubular body that includes a hole for attaching a cable. However, other configurations of the pad eye 218 are possible. The pad eye 218 may resist loads applied to the example suction anchor 200 during deployment on the underwater floor 252 and may also facilitate handling of the example suction anchor 202. For example, the pad eye 218 may allow the example suction anchor 200 to be loaded onto and off of a transport vehicle, such a truck or boat. In some variations, the pad eye 218 extends from an outer surface on a side of the tubular body 202. In these variations, the pad eye 218 may allow the example suction anchor 200, when deployed, to better resist horizontal (e.g., transverse) loads applied to the tubular body 202, in addition to vertical (e.g., axial) and tangential loads. In some variations, the pad eye 218 extends from an outer surface on an apex of the closed end 204 of the tubular body 202. In such variations, the pad eye 218 may allow the example suction anchor 200, when deployed, to better resist vertical (e.g., axial) loads applied to the tubular body 202, in addition to horizontal (e.g., transverse) and tangential loads.

In some implementations, such as shown in FIGS. 2B and 2C, the tubular body 202 includes one or more interior walls 222 partitioning the cavity 216 within the tubular body 202 into a skirt chamber 224 and at least one buoyancy chamber 226. The skirt chamber 224 includes the open end 206 and the edge 208 and fluidly couples to the exterior of the tubular body 202 through a first port 212. Both the skirt chamber 224 and the at least one buoyancy chamber 226 are configured to receive and disgorge fluid (e.g., water, air, etc.) in order to control a flotation capability of the example suction anchor 200. In these implementations, the example suction anchor 200 includes a second port 214, and the at least one buoyancy chamber 226 fluidly couples to the exterior of the tubular body 202 through the second port 214. In many variations, the one or more interior walls 222 are formed at least in part of cementitious materials. The portion of the one or more interior walls 222 formed of cementitious materials may include layers of successively deposited cementitious materials, such as those deposited by 3DCP or 3D-casting processes.

In some implementations, the at least one buoyancy chamber 226 includes a first buoyancy chamber 226a adjacent the closed end 204 of the tubular body 202 and a second buoyancy chamber 226b between the first buoyancy chamber 226a and the skirt chamber 224. The first buoyancy chamber 226a may include a portion of the perimeter wall 210 that defines the closed end 204. In many variations, the first buoyancy chamber 226a is fluidly coupled to the exterior of the tubular body 202 through the second port 214 and the second buoyancy chamber 226b is fluidly coupled to the exterior of the tubular body 202 through a third port. In some variations, the second buoyancy chamber 226b may be partitioned by the one or more interior walls 222 into a plurality of sub-chambers, such as shown in FIGS. 2B and 2C. The plurality of sub-chambers may share a single port fluidly-coupling the second buoyancy chamber 226b to the exterior of the tubular body 202. Alternatively, each sub-chamber may be fluidly coupled to the exterior of the tubular body 202 through a respective port. In some variations, the plurality of sub-chambers are fluidly coupled to each other via holes or orifices in the one or more interior walls 222.

In some variations, such as shown in FIGS. 2B and 2C, the one or more interior walls 222 further partition the cavity 216 of the tubular body 202 into a first conduit 228 and a second conduit 230. The first conduit 228 may fluidly couple the skirt chamber 224 to the first port 212, and the second conduit 230 may fluidly couple the at least one buoyancy chamber 226 to the second port 214. The first and second conduits 228, 230 may be formed at least in part of cementitious materials. However, the first and second conduits 228, 230 may include portions formed of another material, such as metal (e.g., steel) or plastic (e.g., ABS).

As described above, the tubular body 202 and the one or more interior walls 222 may be formed at least in part of cementitious material. In some implementations, the cementitious material includes a means for mechanically strengthening the cementitious material. For example, the cementitious material may include a post-tensioning device disposed therethrough such as in FIG. 2C. The post-tensioning device may include a cable passing through a channel in the cementitious material and set in a tensile state. The channels or reinforcements may be positioned in various directions such as vertically, circumferentially, radially, or in a combination of one or more angles such that the channels or reinforcements result in a spiral path for the post tensioning. The cable may be in direct contact with (or bonded to) the cementitious material. Alternatively, the cable may be disposed through a conduit embedded in the cementitious material defining the channel. The tensile state may allow the cable to apply a compressive pressure or force to the cementitious material. In another example, the cementitious material may include reinforcing elements disposed therein. The reinforcing elements may be configured as fiber, mesh, rebar, and so forth, and may be blended within (and bonded to) the cementitious material. Various materials may be used to form the reinforcement elements, such as steel, basalt, polymers, or glass. However, other materials are possible. In some variations, the body 202 contains voids needed to access the ends of tendons to apply tension to the tendons.

Now referring to FIG. 2C, a schematic diagram is presented, in perspective view, of an example suction anchor 200 that includes a perimeter wall 210 with a spiral configuration of post-tensioning devices 280. The example suction anchor 200 includes a tubular body 202 formed at least in part of cementitious materials. The tubular body 202 includes a closed end 204, an open end 206, and a perimeter wall 210. The perimeter wall 210 defines a shape of the tubular body 202 and is formed at least in part of the cementitious materials. The tubular body 202 includes a channel (e.g., channel 282 or channel 284) and an edge 208. The channel is internal to the perimeter wall 210 and defines a spiral around a longitudinal axis of the tubular body 202. The tubular body 202 also includes an edge 208 defining an opening for the open end 206 that is configured to penetrate an underwater floor.

In some variations, the channel is oriented at substantially 45° to a plane perpendicular to the longitudinal axis of the tubular body 202. However, other angles are possible (e.g., 10°, 30°, 60°, etc.). In FIG. 2C, two channels 282, 284 are shown, i.e., a first channel 282 and a second channel 284. However, other numbers of channels are possible. In some implementations, the channel is oriented at an angle to a plane perpendicular to the longitudinal axis of the tubular body. In these implementations, the angle varies with a position of the plane on the longitudinal axis. The position represents an intersection of the plane with the longitudinal axis. Varying the angle of the channel may be used in certain configurations of the example suction anchor 200 to impart different proportions of circumferential or longitudinal compression in the tubular body 202 (e.g., the perimeter wall 210).

The example suction anchor 200 also includes a post-tensioning device through the channel that is in a tensioned state. In FIG. 2C, two post-tensioning devices are shown, i.e., a first post-tensioning device 286 in the first channel 282 and a second post-tensioning device 288 in the second channel 284. In some variations, the post-tensioning device is in contact with (e.g., bonded to) the walls of the channel. In some variations, the post-tensioning device moves freely in the channel, for example, to allow insertion into or removal from the channel. The example suction anchor 200 additionally includes a port (not shown) configured to fluidly-couple at least part of a cavity within the tubular body 202 to an exterior of the tubular body 202. In some implementations, the example suction anchor 200 may include a pad eye extending from an outer surface of the tubular body 202 and configured to couple to a mooring line.

In some implementations, such as shown in FIG. 2C, the channel is the first channel 282 and the spiral is a first spiral. In these implementations, the tubular body 202 includes the second channel 284, which is internal to the perimeter wall and defines a second spiral around a longitudinal axis of the tubular body 202. The first spiral may a right-handed spiral and the second spiral may be a left-handed spiral. Moreover, the first channel 282 may be oriented at substantially +45° to a plane perpendicular to the longitudinal axis of the tubular body and the second channel 284 may be oriented at substantially −45° to the plane perpendicular to the longitudinal axis of the tubular body. However, other angles are possible for each channel. Moreover, the angles of each channel may vary along longitudinal axis.

In some implementations, the tubular body 202 includes one or more interior walls 222 partitioning the cavity 216 within the tubular body 202 into a skirt chamber 224 and at least one buoyancy chamber 226. The skirt chamber 224 includes the open end 206 and the edge 208 and fluidly couples to the exterior of the tubular body 202 (e.g., through the port). Both the skirt chamber 224 and the at least one buoyancy chamber 226 are configured to receive and disgorge fluid (e.g., water, air, etc.) in order to control a flotation capability of the example suction anchor 200. In these implementations, the example suction anchor 200 may include a second port, and the at least one buoyancy chamber 226 fluidly couples to the exterior of the tubular body 202 through the second port. In many variations, the one or more interior walls 222 are formed at least in part of cementitious materials. The portion of the one or more interior walls 222 formed of cementitious materials may include layers of successively deposited cementitious materials, such as those deposited by 3DCP or 3D-casting processes.

Now referring to FIG. 2E, a schematic diagram is presented of a possible variation of the example suction anchor 200 of FIGS. 2A-2C. For instance, the example suction anchor 200 may be combined with related techniques to produce hybrid structures with one or more manufacturing methods such as 3DCP, 3D casting, shotcrete, or steel. In one variation the closed end 204 may be manufactured using steel fabrication methods to avoid the printing of dome structures or to more easily integrate metallic components such as ports 212, 214, pad eyes 218, stiffening elements 219, or fasteners 242. For example, the closed end may be defined by a dome structure 205 formed of metal or a metal alloy (e.g., steel). The dome structure 205 may include one or more vents, ports (e.g., ports 212, 214) or pad eyes. In some variations, the tendons 240 extend into the closed end 204 or elements of the tubular body 202 to form an integrated structure capable of withstanding or transferring loads, e.g., during installation, removal, and hoisting to other components of the anchor. In this capacity, the tendons 240 may serve as reinforcing tendons.

In some implementations, the edge 208 of the tubular body 202 includes teeth 209 to assist the example suction anchor 200 in penetrating the underwater floor. The teeth 209 may be of cementitious material or metal. For example, the teeth 209 may also be made of metal or a metal alloy (e.g., steel) embedded in cementitious material. In another example, the edge 208 is made of metal or a metal alloy and the teeth 209 are integral to the edge 208 (e.g., also made of the metal or metal alloy). In some variations, the teeth 209 may be configured to be removable from the edge 208. This capability may allow the teeth 209 to be replaced when worn or damaged.

Suction anchors may be fabricated from steel which has good tensile load capabilities. In contrast, 3DSA is most likely made from cementitious materials which have poor tensile load capabilities compared to their compression load carrying capability. Now with reference to FIGS. 2E-2J, various methods can be used to couple the anchor to a mooring line 270 such as a pad eye 218 or bridle 260. One or more pad eye connections are typically used to connect mooring lines to steel suction anchors. The use of a bridle may distribute mooring line loads around the anchor to help ensure that the concrete materials remain in compression. In some variations, the pad eye 218 or bridle 260 are configured to couple to a mooring chain 271 or pad eye connector 272 that, in some instances, may be connected to a mooring line 270.

Now referring to FIGS. 2E-2G and 2J, a pad eye 218 can be coupled to a perimeter wall 210 of the tubular body 202 using reinforcing elements 241, fasteners 242, or other coupling means. In some variations, the reinforcing elements 241 and fasteners 242 can be disposed in the tubular body 202 (e.g., the perimeter wall 210) of the example suction anchor 200. In some variations, the reinforcing elements 241 and fasteners 242 may be placed in a tensile state. In these variations, the reinforcing elements 241 and fasteners 242 may compress a portion of the tubular body 202, a portion of the pad eye 218, or both. In doing so, the reinforcing elements 241 and fasteners 242 may distribute loads from the pad eye 218 more evenly throughout the tubular body 202. The reinforcing elements 241 and fasteners 242 may also distribute loads to a reinforcement system, and in some instances, reduce tensile loads in the tubular body 202 (e.g., in a portion formed of cementitious materials). For example, FIG. 2G depicts an example pad eye connection that can be clamped using fasteners 242 around the tubular body 202 to assist in distributing or transferring loads to other portions of the body 202. In some variations, such as shown in FIG. 2E, the example pad eye connection may be clamped to the tubular body 202.

Now referring to FIGS. 2H-2I, in certain variations of the example suction anchor 200, the use of a bridle 260 may distribute the mooring line loads around the anchor to help ensure the concrete materials remain in compression, such as when resisting forces applied to the anchor by a mooring line 270, a mooring chain 271, or a connecting link 272. In some variations, the bridle 260 is configured to couple to the mooring line using a chain 271 or connecting links 272. Now referring to FIG. 2H, in some variations of the example suction anchor 200, the mooring line is positioned external to the tubular body 202 of the example suction anchor 200 to apply compressive loads to a portion of the perimeter wall 210 when resisting loads from the mooring line 270. In some variations, a belt or fixture 261 is used to transfer loads to the tubular body 202. Features such as depressions or voids can be included in the tubular body 202 (e.g., in the perimeter wall 210) to distribute the loads from one or more bridle lines 260 to a larger area across the tubular body 202. In some variations the tubular body 202 may incorporate depressions or connectors such as stays or pad eyes to assist in maintaining a position of the bridle on the anchor. Now referring to FIG. 2I, the bridle 260 can be embedded into a wall of the example suction anchor 200 (e.g., the perimeter wall 210) to assist in maintaining the position of the bridle 260. In other variations, an external surface 262 that may include a channel can be embedded into the example suction anchor 200 (e.g., the tubular body 202, the perimeter wall 210, etc.) as part of the concrete manufacturing process to aid in the positioning of a bridle.

Now referring to FIG. 2J, the method is shown for placing overlapping tendons 240 (or post-tensioning devices) in a spiral, thereby creating a compressive effect in the tubular body 202, such as in the perimeter wall 210. The tendons 240 may include one or more tendons defining a right-handed spiral and one or more tendons defining a left-handed tendon. This compressive effect may better resist out-of-plane bending loads applied to the example suction anchor 200 compared to using tendons aligned in only longitudinal or circumferential directions. The tendons 240 can be tensioned after printing at the closed end 204, the open end 206, both ends, or other locations within the tubular body 202. Such tensioning can help ensure a more even tensioning in the tendons by avoiding increases in friction. The spiral post-tension system has potential to increase the ultimate capacity of the example suction anchor 200 in a three-point bending test by approximately 45% when compared to anchors having only longitudinally aligned tendons. In some variations, spiral post tensioning can be used to reduce or eliminate circumferential post tensioning, thereby reducing the number of components, assembly labor, and suction anchor cost. Varying an angle of the tendons 240 can be used in certain cases to achieve different proportions of circumferential or longitudinal compression in the anchor. In some variations, the angle of the spiral reinforcement 240 varies along the length of the example suction anchor 200.

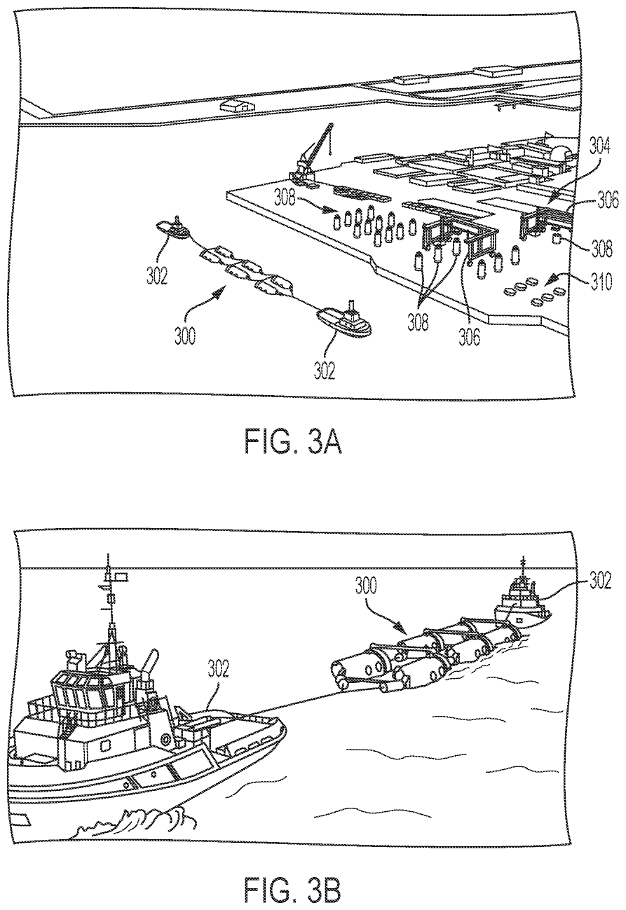

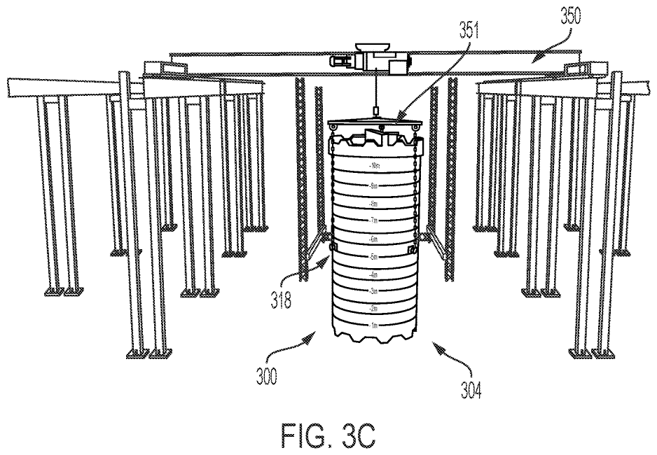

During operation, the example suction anchor 200 may transition through multiple stages of use, including deployment, self-penetration, embedment, and removal. For the deployment stage, the example suction anchor 200 (or 3DSA) are manufactured and assembled into 3DSA units, optionally linked to other units, and horizontally wet-towed to the installation site with common tugs. FIG. 3A presents a schematic diagram, in perspective view, of a group of 3DSA units 300 being horizontally wet-towed by tugboats 302 from a quay 304 where the 3DSA units 300 were manufactured and assembled. The quay 304 includes systems 306 for the manufacture of suction anchors 308, lids 310, or both by 3DCP or 3D-casting processes. FIG. 3B presents a schematic diagram, in perspective view, of assembled 3DSA units 300 of FIG. 3A being horizontally wet-towed by tugboats 302 along an open body of water to a target location. More conventional suction anchor transportation and installation methods can be used if desired such as placing the 3DSA units 300 on the deck of an anchor handling vessel or barge for transportation to the installation site. The 3DSA units may be secured directly to the deck or rest upon a secondary structure such as a cradle to resist movement during transport. FIG. 3C presents an example of using a crane 350, spreader bar 351, and lifting eyes and lifting lugs 318 to lift the 3DSA unit 304 (or suction anchor 300). The example suction anchor 200 (or a 3DSA unit 300) is lowered by flooding the at least one buoyancy chamber 226 with water in a controlled fashion, such a through a pump and valve system.

After the example suction anchor 200 lowers onto the underwater floor 252, the edge 208 of the skirt chamber 224 (or tubular body 202) penetrates into the underwater floor 252 and the skirt chamber 224 (or tubular body 202) partially embeds under self-weight up to approximately 30% of its height depending on soil conditions and properties of the example suction anchor 200. Such embedment corresponds to a self-penetration of the example suction anchor 200 into the underwater floor 252. By incorporating cementitious materials, the example suction anchor 200 is heavier relative to conventional designs. This heavier construction is synergistic with deployment because the moderately heavier mass increases the self-penetration depth of the skirt chamber 221 (or tubular body 202) as well as increasing a lift and overturning capacity of the example suction anchor 200 by reducing the diameter, length, and cost.

During the embedment stage, embedment into the underwater floor 252 (or further embedment) is achieved by the pressure differential caused by the pumping of the water out of the skirt chamber 224 (or cavity 216), such as through the one or more ports 212, 214 (or hatches). Such pumping creates what is called an “underpressure,” which is a negative pressure differential (relative to ambient pressure) developed inside the skirt chamber 224 (or cavity 216) when pumping water out. The resultant pressure differential across walls defining the skirt chamber 224 (or cavity 216) effectively pushes the example suction anchor 200 into the underwater floor 252. The pump(s) and lid 220 may then returned to the port-side point of departure (e.g., a dock, a quay, etc.) for reuse. FIG. 2D illustrates instances of the example suction anchor 200 securing different types of structures, such as semi-submersible structures (i.e., the wind turbine structure 250 on the left) and spar foundations (i.e., the wind turbine structure 250 on the right). FIG. 2D also illustrates the example suction anchor 200 coupled to the wind turbine structures 250 with different mooring types, including taut or semi-taut mooring (left) and slack or catenary mooring (right). For removal, the example suction anchor 200 can be retrieved after use by reversing the embedment process, e.g., applying an “overpressure” inside the skirt chamber 224 (or cavity 216). The over pressure is a positive pressure differential (relative to ambient pressure) inside the tubular body 202 when pumping water out of the skirt chamber 224 (or cavity 216) to extract the example suction anchor 200. Such pumping may also include introducing air into the skirt chamber 224 (or cavity 216) by action of an air compressor.

The 3DCP suction anchors, such as described herein, may reduce the installed costs by up to 80% compared to conventional suction buckets fabricated by rolling steel plates and installed via specialized and costly anchor-handling vessels. Furthermore, the 3DCP suction anchors can be manufactured using existing concrete supply chains located in nearly every region of the country. 3D concrete printing or 3DCP, is a relatively new concrete manufacturing technology that reduces manufacturing capital cost by eliminating construction formwork, increasing automation, and using low-cost, corrosion-resistant, and domestically available concrete materials. While several concrete manufacturing methods are capable of manufacturing 3D suction anchor modules (such as precast reinforced concrete, cast in place concrete, or slip formed concrete), 3DCP has the potential for the most cost reduction due to the extent of automated on-site fabrication and ability to manufacture complex shapes.

The 3DCP process facilitates optimal material distribution within a functionally optimized shape without building conventional formwork. For example, walls defining an edge of a skirt chamber can easily be tapered to facilitate embedment without the need of further fabrication or tooling. Similarly, the 3D suction anchors could be equipped with void chambers to realize necessary buoyancy for horizontal wet towing. Such compartmental floatation chambers offer additional structural capacity and mass to resist uplift, and the pneumatic inner ducts among the various chambers and post-tensioned reinforcement chambers are fabricated and integrated in the printing process.

The 3DSA's can be manufactured directly at the quay (e.g. see FIG. 3A), as one piece or in sub-modules if necessary, depending on the application requirements and sizes. The 3DCP process may print the 3D suction anchor next to a pre-manufactured lid to ensure a water-tight fit. The suction anchors may be post-tensioned with tendon jacks located along a perimeter of the skirt chamber. The suction anchors may also be fitted with pneumatic valves, pump connectors, bottom plugs, and then pressure tested.

In some implementations, a method of manufacturing a suction anchor includes depositing layers of flowable cementitious material on top of each other to form at least part of a tubular body. The layers of flowable cementitious material may be deposited successively on top of each other such that a subsequent layer comes in direct contact with a prior layer. The flowable cementitious material is capable of hardening into solidified cementitious material. The tubular body includes a closed end and an open end. The tubular body also includes a perimeter wall defining a shape of the tubular body and formed at least in part of the deposited layers of flowable cementitious material. The tubular body additional includes an edge and a port. The edge defines an opening for the open end and is configured to penetrate an underwater floor. The port is configured to fluidly-couple at least part of a cavity within the tubular body to an exterior of the tubular body. The method also includes forming, while depositing the layers of flowable cementitious material, a channel internal to the perimeter wall that defines a spiral around a longitudinal axis of the tubular body.

In some implementations, the channel is oriented at substantially 45° to a plane perpendicular to the longitudinal axis of the tubular body. In some implementations, the channel is oriented at an angle to a plane perpendicular to the longitudinal axis of the tubular body. In these implementations, forming a channel while depositing includes varying the angle with a position of the plane on the longitudinal axis. The position represents an intersection of the plane with the longitudinal axis.

In some implementations, the method further includes disposing a post-tensioning device through the channel and tensioning the post-tensioning device after the layers of flowable cementitious material harden into layers of solidified cementitious material.

In some implementations, the channel is a first channel and the spiral is a first spiral. In these implementations, forming a channel while depositing includes forming a second channel internal to the perimeter wall that defines a second spiral around a longitudinal axis of the tubular body. In some variations, the first spiral is a right-handed spiral and the second spiral is a left-handed spiral. In these variations, the first channel may be oriented at substantially +45° to a plane perpendicular to the longitudinal axis of the tubular body and the second channel may be oriented at substantially −45° to the plane perpendicular to the longitudinal axis of the tubular body.

In some implementations, the method also includes securing a pad eye to a wall of the tubular body. The pad eye is configured to couple to a mooring line. In some variations, the method may include securing a bridle to a wall of the tubular body that is configured to connect to a mooring line.

In some implementations, the method includes hardening the layers of flowable cementitious material into layers of solidified cementitious material. In some implementations, the method includes disposing reinforcing elements in the flowable cementitious material before depositing the layers. In some implementations, depositing the layers of flowable cementitious material includes embedding a support structure in the layers of flowable cementitious material. The support structure may include a mesh, a cage, or an assembly of coupled rods or bars formed of steel, basalt, or glass fiber. In further implementations, the method includes coupling rebar elements to each other to define at least part of the support structure.

In some implementations, forming a channel includes leaving space within the layers of flowable cementitious material to form the channel. In some implementations, forming a channel includes embedding a conduit in the layers of flowable cementitious material. The conduit defines the channel internal to the perimeter wall. In some implementations, the forming a channel includes inserting a conduit through the layers of flowable cementitious material before the layers harden. The conduit defines the channel internal to the perimeter wall.

In some variations, related structures (e.g., sections made of concrete or rolled steel shapes) can be placed and joined directly on top of an anchor section of the tubular body. Fasteners or post-tensioning tendons may be part of a method to pre-stress the tubular body. In many variations, the fasteners or post-tensioning tendons extend into the closed end or the open end of the tubular body.

In some implementations, depositing the layers of flowable cementitious material includes spraying layers of the flowable cementitious material on top of each other. In some implementations, depositing the layers of flowable cementitious materials includes printing layers of the flowable cementitious material on top of each other.

In some implementations, the portion of the tubular body formed by the layers of flowable cementitious material includes a first portion and a second portion. In such implementations, depositing the layers of flowable cementitious material includes depositing first layers of flowable cementitious material on top of each other to form the first portion. Depositing the layers of flowable cementitious material also includes hardening the first layers of flowable cementitious material to solidify the first portion and depositing second layers of flowable cementitious material on the solidified first portion to form the second portion. The second layers are deposited on top of each other.

In some implementations, the tubular body includes one or more interior walls partitioning the cavity within the tubular body into a skirt chamber and at least one buoyancy chamber. The skirt chamber includes the open end and the edge of the tubular body, and the port fluidly couples the skirt chamber to the exterior of the tubular body. The tubular body also includes a second port configured to fluidly couple the at least one buoyancy chamber to the exterior of the tubular body. In some variations, the portion of the tubular body formed by the layers of flowable cementitious material includes the one or more interior walls.

In some implementations, the edge of the tubular body is formed of metal. In these implementations, depositing the layers of flowable cementitious material includes contacting a surface of the edge with one or more layers of flowable cementitious material. In some variations, the method includes coupling the port to the support structure. In some variations, securing the pad eye to the exterior wall includes coupling the pad eye to the support structure. The support structure includes a portion configured to reinforce the exterior wall adjacent the pad eye.

In some implementations, a suction anchor for securing structures to an underwater floor includes a tubular body formed at least in part of cementitious materials. The tubular body has a closed end, an open end, and a perimeter wall. The perimeter wall defines a shape of the tubular body and is formed at least in part of the cementitious materials. The tubular body also includes a channel and an edge. The channel is internal to the perimeter wall and defines a spiral around a longitudinal axis of the tubular body. The edge defines an opening for the open end and is configured to penetrate an underwater floor. The suction anchor also includes a post-tensioning device through the channel in a tensioned state and a port configured to fluidly-couple at least part of a cavity within the tubular body to an exterior of the tubular body.

In some implementations, the suction anchor also includes a pad eye extending from an outer surface of the tubular body and configured to couple to a mooring line. In some implementations, the channel is oriented at substantially 45° to a plane perpendicular to the longitudinal axis of the tubular body. In some implementations, the channel is oriented at an angle to a plane perpendicular to the longitudinal axis of the tubular body. In these implementations, the angle varies with a position of the plane on the longitudinal axis. The position represents an intersection of the plane with the longitudinal axis.

In some implementations, the channel is a first channel and the spiral is a first spiral. In these implementations, the tubular body includes a second channel internal to the perimeter wall that defines a second spiral around a longitudinal axis of the tubular body. The first spiral may be a right-handed spiral and the second spiral may be a left-handed spiral. Moreover, the first channel may be oriented at substantially +45° to a plane perpendicular to the longitudinal axis of the tubular body and the second channel may be oriented at substantially −45° to the plane perpendicular to the longitudinal axis of the tubular body.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described components and systems can generally be integrated together in a single product or packaged into multiple products.

A number of embodiments have been described. Nevertheless, it will be understood that various modifications can be made. Accordingly, other embodiments are within the scope of the disclosure.

What is claimed is:

1. A method of manufacturing a suction anchor, comprising:
depositing layers of flowable cementitious material on top of each other to form at least part of a tubular body, the flowable cementitious material capable of hardening into solidified cementitious material, the tubular body comprising:
a closed end and an open end,
a perimeter wall defining a shape of the tubular body and formed at least in part of the deposited layers of flowable cementitious material,
an edge defining an opening for the open end and configured to penetrate an underwater floor, and
a port configured to fluidly-couple at least part of a cavity within the tubular body to an exterior of the tubular body; and
while depositing, forming a channel internal to the perimeter wall that defines a spiral around a longitudinal axis of the tubular body.

2. The method of claim 1, comprising:
disposing a post-tensioning device through the channel, and
tensioning the post-tensioning device after the layers of flowable cementitious material harden into layers of solidified cementitious material.

3. The method of claim 1, wherein the channel is oriented at substantially 45° to a plane perpendicular to the longitudinal axis of the tubular body.

4. The method of claim 1,
wherein the channel is oriented at an angle to a plane perpendicular to the longitudinal axis of the tubular body; and
wherein forming a channel while depositing comprises varying the angle with a position of the plane on the longitudinal axis, the position representing an intersection of the plane with the longitudinal axis.

5. The method of claim 1,
wherein the channel is a first channel and the spiral is a first spiral; and
wherein forming a channel while depositing comprises forming a second channel internal to the perimeter wall that defines a second spiral around a longitudinal axis of the tubular body.

6. The method of claim 5, wherein the first spiral is a right-handed spiral and the second spiral is a left-handed spiral.

7. The method of claim 5,
wherein the first spiral is a right-handed spiral and the second spiral is a left-handed spiral; and
wherein the first channel is oriented at substantially +45° to a plane perpendicular to the longitudinal axis of the tubular body and the second channel is oriented at substantially −45° to the plane perpendicular to the longitudinal axis of the tubular body.

8. The method of claim 1, comprising:
hardening the layers of flowable cementitious material into layers of solidified cementitious material.

9. A suction anchor for securing structures to an underwater floor, the suction anchor comprising:
a tubular body formed at least in part of cementitious materials and comprising:
a closed end and an open end,
a perimeter wall defining a shape of the tubular body and formed at least in part of the cementitious materials,
a channel internal to the perimeter wall defining a spiral around a longitudinal axis of the tubular body,
an edge defining an opening for the open end and configured to penetrate an underwater floor;
a post-tensioning device through the channel in a tensioned state; and
a port configured to fluidly-couple at least part of a cavity within the tubular body to an exterior of the tubular body.

10. The suction anchor of claim 9, comprising:
a pad eye extending from an outer surface of the tubular body and configured to couple to a mooring line.

11. The suction anchor of claim 9, wherein the channel is oriented at substantially 45° to a plane perpendicular to the longitudinal axis of the tubular body.

12. The suction anchor of claim 9,
wherein the channel is oriented at an angle to a plane perpendicular to the longitudinal axis of the tubular body; and
wherein the angle varies with a position of the plane on the longitudinal axis, the position representing an intersection of the plane with the longitudinal axis.

13. The suction anchor of claim 9,
wherein the channel is a first channel and the spiral is a first spiral; and
wherein the tubular body comprises a second channel internal to the perimeter wall that defines a second spiral around a longitudinal axis of the tubular body.

14. The suction anchor of claim 13, wherein the first spiral is a right-handed spiral and the second spiral is a left-handed spiral.

15. The suction anchor of claim 13,
wherein the first spiral is a right-handed spiral and the second spiral is a left-handed spiral; and
wherein the first channel is oriented at substantially +45° to a plane perpendicular to the longitudinal axis of the tubular body and the second channel is oriented at substantially −45° to the plane perpendicular to the longitudinal axis of the tubular body.

16. The suction anchor of claim 13, comprising a bridal configured to couple to a mooring line and distribute mooring line loads around the perimeter wall.
